(19) United States
(12) Patent Application Publication
(10) Pub. No.: US 2006/0210945 A1
(43) Pub. Date: Sep. 21, 2006

(54) Positioning aid for positioning teeth

(75) Inventors: Novica Savic, Ranstadt (DE); Olaf Mrotzek, Wasserburg (DE); Dieter Ehret, Altheim-Alb. (DE)

Correspondence Address: Norris, McLaughlin & Marcus P.A., 18th Floor, 875 Third Avenue, New York, NY, 10022, US

(73) Assignee: Heraeus Kulzer GmbH, Hanau (DE)

(21) Appl. No.: 11/343,584

(22) Filed: Jan. 31, 2006

(30) Foreign Application Priority Data
Mar. 21, 2005 (DE) 10 2005 013 459.9

(51) Int. Cl. A61C 19/04; A61C 11/00

(52) U.S. Cl. 433/68; 433/56

(57) ABSTRACT

The invention relates to a positioning aid for positioning teeth, especially in producing dental prostheses, having a tooth positioning guide with movable tooth blocks, and consists of the fact that the tooth blocks have dental impressions for receiving teeth.

This invention relates to a positioning aid for positioning teeth, in particular in manufacturing prostheses, with a tooth positioning guide with movable tooth blocks.

Such positioning aids are known from DE 86 17 182 U1, for example. This positioning aid consists essentially of a holder which can be secured on an articulator in relation to a model of the mandible and two inserts that are shiftable and are pivotable in a plane, with the help of which it is possible to position one of the side teeth of a mandibular prosthesis. Articulators are also described in DE 197 26 725 A1 and DE 199 56 876 A1, for example. DE 197 26 725 A1 also describes the arrangement of a simple positioning aid in an articulator.

Preparing prostheses, in particular total prostheses, is very time-consuming, in particular for correct positioning of the individual teeth. The known devices only simplify the alignment of teeth with regard to one plane and any other positioning must be performed in a time-consuming manual procedure.

The object of the present invention is to simplify the positioning of the teeth of a prosthesis.

This object is achieved by the features of the main claim. Advantageous embodiments are characterized in the subclaims.

Due to the fact that the dental blocks have dental impressions for receiving teeth, the positioning aid ensures accurate positioning of artificial prosthetic teeth in dentition without restriction of the individual function pattern of the patient while at the same time shortening the labor required by up to 80% in comparison with the known methods. It is expedient that the dental impressions are arranged on the top and bottom sides of the dental blocks. The dental blocks are advantageously designed as side tooth blocks to accommodate side teeth. All recognized ideal occlusions, i.e., balanced occlusions, protective occlusions, lingualized occlusions and group-guided occlusions can be implemented in a simple manner through appropriately prefabricated and replaceable tooth blocks (side tooth blocks) in a simple manner with such a side tooth positioning guide without requiring any basic prior knowledge. The dental impressions which secure the complete maxillary/mandibular side tooth blocks are used for anatomically correct positioning of artificial side teeth. The dental positioning guide can be shifted freely on the working masticatory plane toward all sides into the anatomically correct position for the individual patient and secured there. It is expedient here for the side block teeth to be arranged so that they are pivotable and/or displaceable. In addition, the dental blocks are appropriately removably arranged on the tooth positioning guide.

The positioning aid may be arranged on an articulator in such a way that a basic device is arranged on the dental positioning guide, having connections for attachment to the articulator. The basic device is connected to the tooth positioning guide via a connecting module, preferably a plug connection in particular.

It is expedient for a positioning opening to be provided between the top side and the bottom side in the dental blocks. Through such an opening (hole) in the dental blocks, in particular at the tip of the mesiopalatal cusp of the first upper-jaw molar, its exact spatial positioning is determined with the help of a laser pointer. The static positioning above the ridge of the jaw is performed by marking at the mesial and distal borders of the tooth blocks.

It is important for a front tooth table, to be arranged on the tooth positioning guide, preferably removably. The front tooth table serves to align the maxillary front teeth in a horizontal plane. To be able to ensure the front tooth positions according aesthetic and phonetic facial aspects, the front tooth table is removable and is designed without impressions in particular. The positioning aid advantageously has a device for height adjustment and stabilization of the horizontal position. Its device, which connects a carrier pin to a supporting mandrel, e.g., by means of a screw thread, may be attached to the articulator.

The tooth positioning guide advantageously has a pivot axis for joint pivoting of the dental blocks, making it possible for the tooth positioning guide to be pivoted upward, e.g., via a pivot axis implemented by a hinge. This ensures that the mandibular side teeth can be freely positioned in the impressions and that any equalization of the dental bases to the jaw profile is possible. The device for height adjustment may ensure accurate resetting of the tooth positioning guide in the working masticatory plane.

Because of the plurality of articulators, it is necessary to adjust the basic device, in particular its connections, to the articulator and/or to prepare a corresponding basic device for each type of articulator. Use of adaptors between the basic device and articulator is possible. In any case the basic device must be secured in the articulator. So-called condyls (hinge axes) are used for this purpose.

By replacing the dental blocks, practically any type of dentition can be achieved. The impressions are expediently more or less accurately adapted to prosthetic teeth available on the market. Due to the replaceability of the dental blocks, different teeth may be used, thus making it possible to take into account individual adjustments.

An exemplary embodiment of the present invention is described below with reference to a drawing in which:

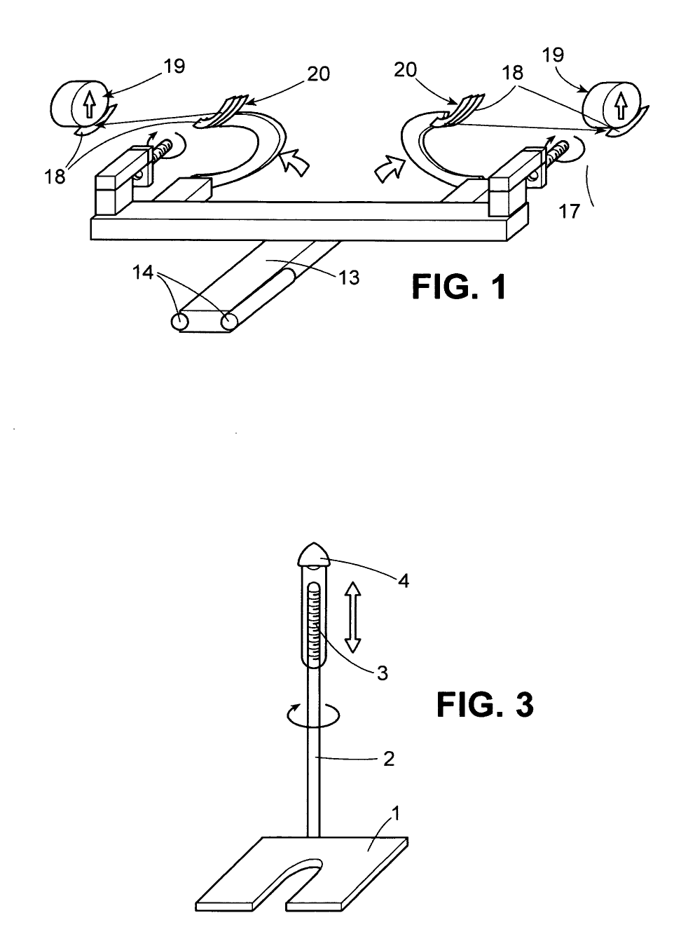

FIG. 1 shows a basic device

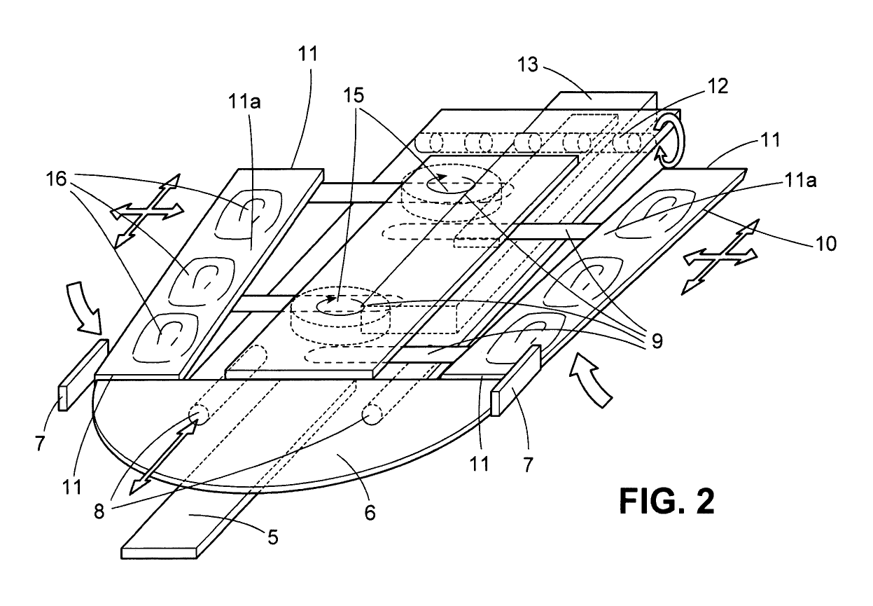

FIG. 2 shows a tooth positioning guide and

FIG. 3 shows a device for height adjustment.

The three figures are arranged according to their factual relationship to one another. Since the basic arrangement of a positioning aid in an articulator is known from the state of the art cited in the beginning, reference is made in this regard to the state of the art and the arrangement in the articulator will not be explained in greater detail for reasons of simplicity.

The basic device has a condyl receptacle 20 on the right and left sides, each holding a condyl 19. The position of the condyls 19 is adapted to the concrete articulator by means of spacers 18. The spacers may be raised by approximately 2 to 3 mm on each side. The device for height adjustment must also be raised by the same amount. A horizontal alignment of the basic device in the articulator is accomplished by means of locking screws 17 and optionally also its attachment.

By means of a plug connection 13, the tooth positioning guide (side tooth positioning guide) is arranged on the basic device and secured by means of securing pins 14. The tooth positioning guide shown in FIG. 2 has a side tooth block 10 on the right side and another on the left, each of which can be shifted and pivoted in a plane with the help of movable carrier arms 9. The positioning screws 15 serve to secure the correct position of the side tooth blocks 10.

The side tooth blocks 10 have dental impressions 16 for the maxillary and mandibular side teeth, respectively, and one stop 7 each for the respective canine tooth. The hole checkpoint 11a is arranged on the location of the respective side tooth block 10 corresponding to the tip of the mesiopalatal cusp on the first maxillary molar. The positioning of this maxillary molar is determined with the help of a laser pointer. The side tooth blocks 10 also carry additional marking points 11 on the mesial and distal borders of the side tooth blocks 10, permitting accurate positioning over the ridge of the jaw.

The tooth positioning guide can be flipped upward by means of the axis of rotation 12 to position the side teeth of the mandible in the impressions. The removable front tooth table 6 is secured and adjusted in position with the help of securing pins 8. It serves to align the maxillary front teeth in the horizontal plane. Furthermore, the tooth positioning guide has a supporting arm 5 on which the threaded sleeve 4 acts. The supporting arm 5 and thus the tooth positioning guide are adjusted in their horizontal positions with the help of the threaded sleeve 4. To do so the threaded sleeve 4 can be adjusted in height by means of the thread 3 of the supporting mandrel 2. The supporting mandrel 2 is held on a base plate 1, which is in turn attached to the articulator.

1. Positioning aid for positioning teeth, in the production of a prosthesis, comprising a tooth positioning guide having movable tooth blocks, wherein the tooth blocks have dental impressions for receiving teeth.

2. Positioning aid according to claim 1, wherein the dental impressions are arranged on the top and bottom sides of the tooth blocks.

3. Positioning aid according to claim 1, wherein the tooth blocks are designed as side tooth blocks to receive side teeth.

4. Positioning aid according to claim 1, wherein the tooth blocks are arranged pivotably and/or displaceably.

5. Positioning aid according to claim 1, wherein the tooth blocks are removably positioned on the tooth positioning guide.

6. Positioning aid according to claim 1, wherein a tooth positioning device is arranged on the tooth positioning guide, said tooth positioning device having connections for connecting it to an articulator.

7. Positioning aid according to claim 6, wherein said tooth positioning device is connected to the tooth positioning guide by way of a connecting module.

8. Positioning aid according to claim 1, wherein a positioning hole is provided in the tooth blocks between their top and bottom sides.

9. Positioning aid according to claim 1, wherein a front tooth table is arranged, on the tooth positioning guide.

10. Positioning aid according to claim 1, further comprising a device for height adjustment.

11. Positioning aid according to claim 1, wherein the tooth positioning guide has a pivot axis for joint pivoting of the tooth blocks.

12. Positioning aid according to claim 7, wherein said connecting module is a plug connection.

13. Positioning aid according to claim 9, wherein said front tooth table is removably arranged on the tooth positioning guide.
